(19) United States
(12) Patent Application Publication
(10) Pub. No.: US 2008/0069943 A1
(43) Pub. Date: Mar. 20, 2008

(54) Process for preparing a frozen shrimp product

(76) Inventor: Hann-Kuang Chen, Kaohsiung City (TW)

Correspondence Address: SEYFARTH SHAW LLP, 131 S. DEARBORN ST., SUITE 2400, CHICAGO, IL, 60603-5803, US

(21) Appl. No.: 11/523,406

(22) Filed: Sep. 18, 2006

(51) Int. Cl. A23L 1/325

(52) U.S. Cl. 426/643

(57) ABSTRACT

A process for preparing a frozen shrimp product includes the steps of: (a) placing a first raw shrimp in a confining space of a confining member; (b) stacking a second raw shrimp on the first raw shrimp in the confining space of the confining member using a binder; (c) pressing the second raw shrimp against the first raw shrimp in the confining space of the confining member so as to form a shrimp product; (d) taking out the shrimp product from the confining member; and (e) freezing the shrimp product taken out from the confining member.

### BACKGROUND OF THE INVENTION

1. Field of the Invention

This invention relates to a process for preparing a frozen shrimp product.

2. Description of the Related Art

In general, large shrimps can induce appetite and provide a good selling appearance. However, large shrimps are relatively expensive. Hence, a composite shrimp product 9 has been proposed. As shown in FIG. 1, the composite shrimp product 9 includes first and second peeled raw shrimps 91, each of which is formed with a butterfly slit so as to configure each of them into two butterfly halves. After partly stacking the butterfly halves of the first and second peeled raw shrimps 91 onto each other, the stacked shrimps are subjected to a pressing force so as to bond the two shrimps 91 together using the mucus secreted therefrom.

The aforesaid composite shrimp product 9 is disadvantageous in that since the connection between the first and second peeled raw shrimps 91 merely relies on the mucus adhesion, undesired separation of the first and second peeled raw shrimps 91 is likely to occur during shipping or cooking.

### SUMMARY OF THE INVENTION

Therefore, it is an object of the present invention to provide a process for preparing a frozen shrimp product that is capable of overcoming the aforesaid disadvantage of the prior art.

According to this invention, a process for preparing a frozen shrimp product, comprises the steps of: (a) placing a first raw shrimp in a confining space of a confining member; (b) stacking a second raw shrimp on the first raw shrimp in the confining space of the confining member using a binder; (c) pressing the second raw shrimp against the first raw shrimp in the confining space of the confining member so as to form a shrimp product; (d) taking out the shrimp product from the confining member; and (e) freezing the shrimp product taken out from the confining member.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic view of a composite shrimp product made by a conventional process;

FIG. 2 is a perspective view showing a frozen shrimp product prepared by the process of the first preferred embodiment according to this invention;

FIG. 3 is an exploded perspective view showing a pair of shrimps placed in a confining space of a confining member according to the process of the first preferred embodiment;

FIG. 4 is a schematic cross-sectional view to illustrate how the two shrimps are bonded together in the confining space of the confining member according to the first preferred embodiment;

FIG. 5 is a perspective view showing a casing for accommodating the shrimp products prepared by the first preferred embodiment;

FIG. 6 is a perspective view showing a frozen shrimp product prepared by the process of the second preferred embodiment according to this invention;

FIG. 7 is a schematic cross-sectional view to illustrate how three shrimps are bonded together in the confining space of the confining member according to the second preferred embodiment;

FIG. 8 is a perspective view showing a frozen shrimp product prepared by the process of the third preferred embodiment according to this invention;

FIG. 9 is an exploded perspective view showing a pair of shrimps placed in a confining space of a confining member according to the third preferred embodiment;

FIG. 10 is a perspective view showing a frozen shrimp product prepared by the process of the fourth preferred embodiment according to this invention; and

FIG. 11 is an exploded perspective view showing the configuration of the confining member for receiving first, second, and third shrimps therein according to the process of the fourth preferred embodiment.

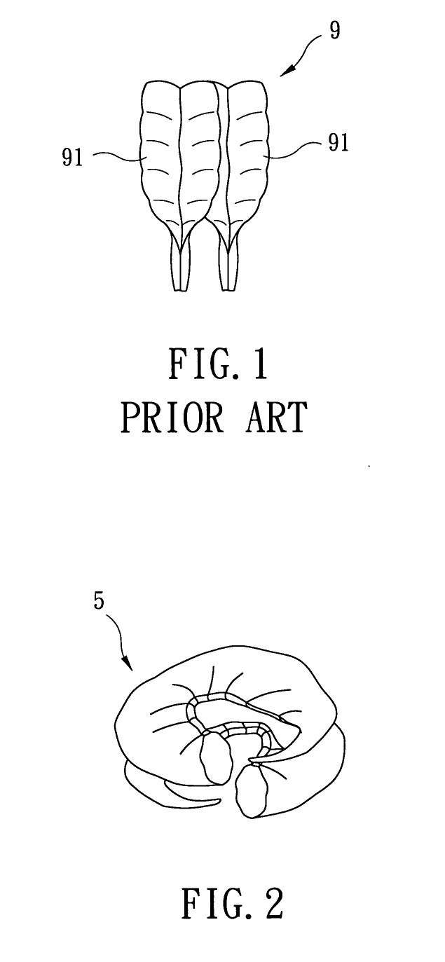

### DETAILED DESCRIPTION OF THE PREFERRED EMBODIMENTS

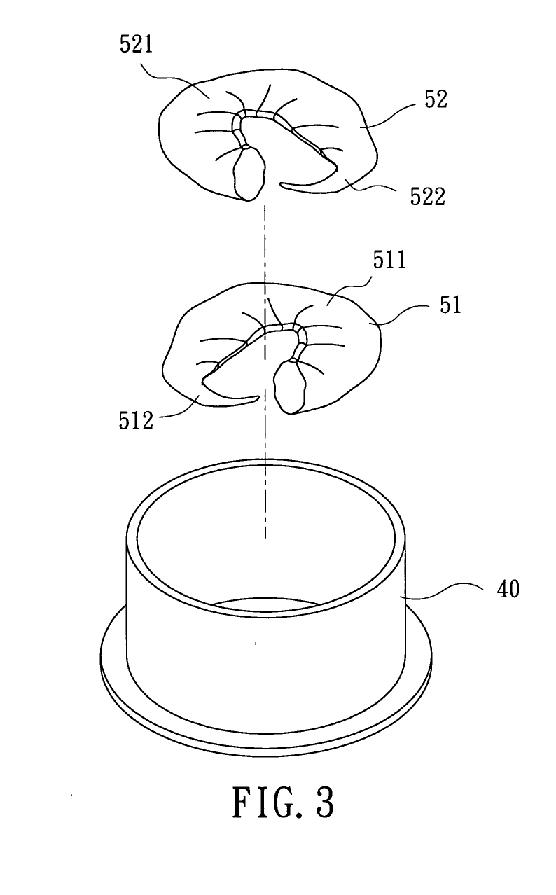

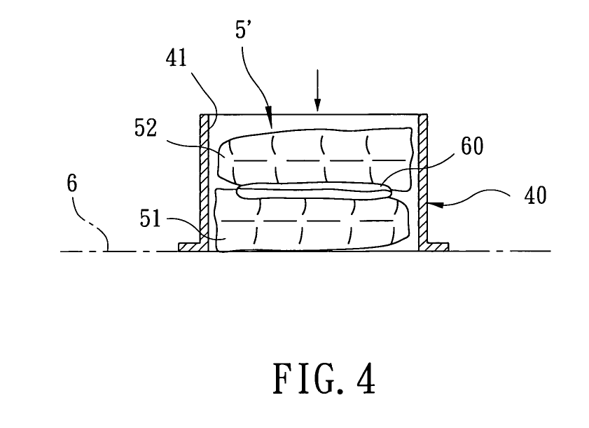

FIG. 2 shows a frozen shrimp product 5 made by the first preferred embodiment of a process according to the present invention. The process for preparing the frozen shrimp product 5 includes the steps of: (a) placing a first raw shrimp 51 in a confining space 41 of a confining member 40 disposed on a work table 6 (see FIGS. 3 and 4); (b) stacking a second raw shrimp 52 on the first raw shrimp 51 in the confining space 41 of the confining member 40 using a binder 60 (see FIGS. 3 and 4); (c) pressing the second raw shrimp 52 against the first raw shrimp 51 in the confining space 41 of the confining member 40 by applying a force (indicated by the arrow shown in FIG. 4) to the second raw shrimp 52 for about three minutes so as to form a stack of a shrimp product 5′ (see FIG. 4); (d) taking out the shrimp product 5′ from the confining member 40; and (e) freezing the shrimp product 5′ taken out from the confining member 40.

The binder 60 includes 70 wt % of protein, 25 wt % of a mixture of sodium chloride and natural shell calcium, and 5 wt % of polysaccharide. However, it should be noted that, during the pressing step, the mucus of the shrimps is likely to be released from the shrimps 51, 52 so that, in addition to the binder 60, the mucus also facilitates the bonding between the two shrimps 51, 52. Moreover, the pressing step also increases the bonding area between the two shrimps 51, 52.

As shown in FIG. 3, in this embodiment, the first raw shrimp 51 and the second raw shrimp 52 are peeled. The confining space 41 is cylindrical in shape so that the shrimp product 5′ and the frozen shrimp product 5 have a circular shape.

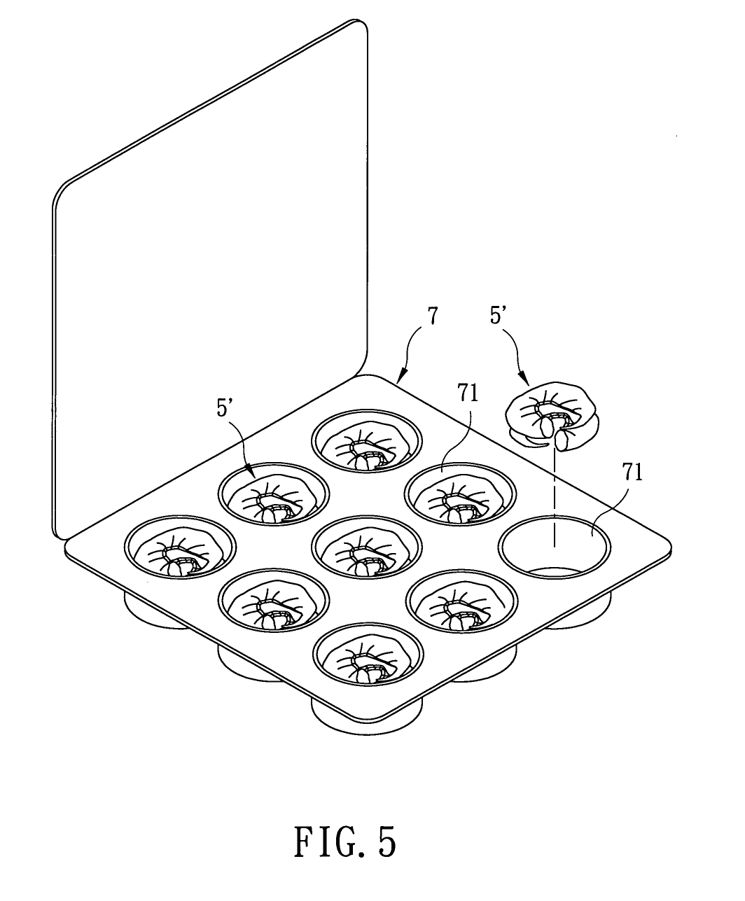

Moreover, in this embodiment, a plurality of shrimp product 5′ are prepared, and each of them may be placed in a respective one of grooves 71 in a casing 7 (see FIG. 5).

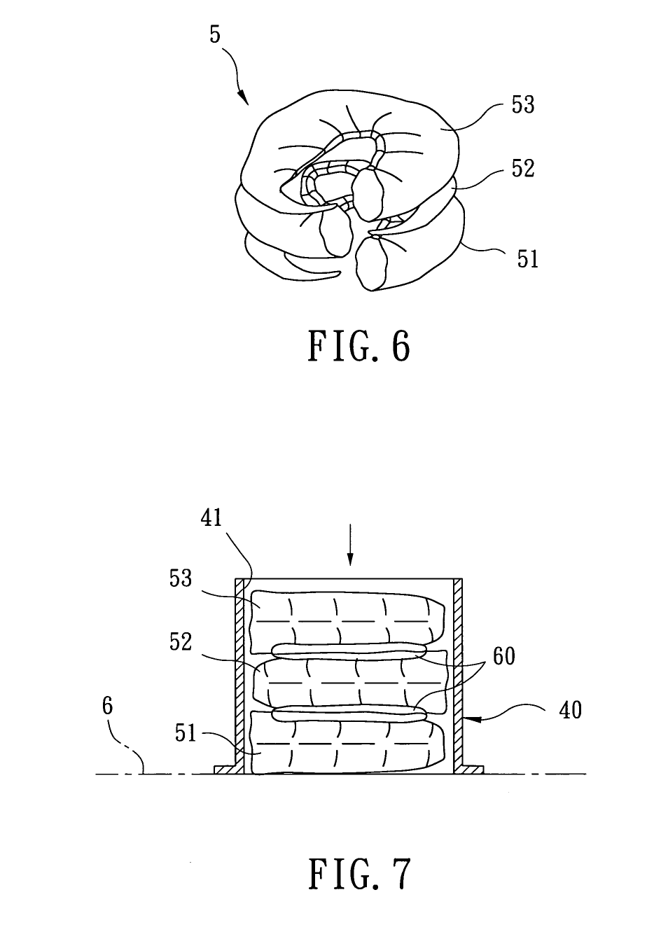

FIGS. 6 and 7 show a frozen shrimp product 5 made by the second preferred embodiment of a process according to the present invention. This embodiment differs from the previous embodiment in that the process further includes, before step (d), stacking a third peeled shrimp 53 on the second peeled shrimp 52 using the binder 60, and pressing the third raw shrimp 53 against the first and second raw shrimps 51, 52 to form a stack of the shrimp product 5.

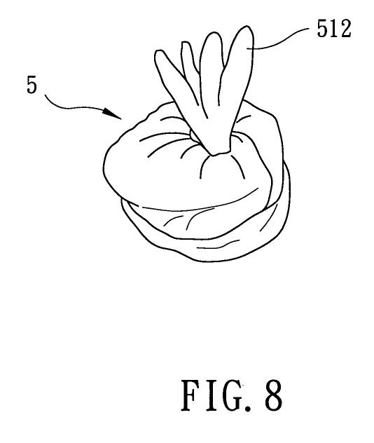

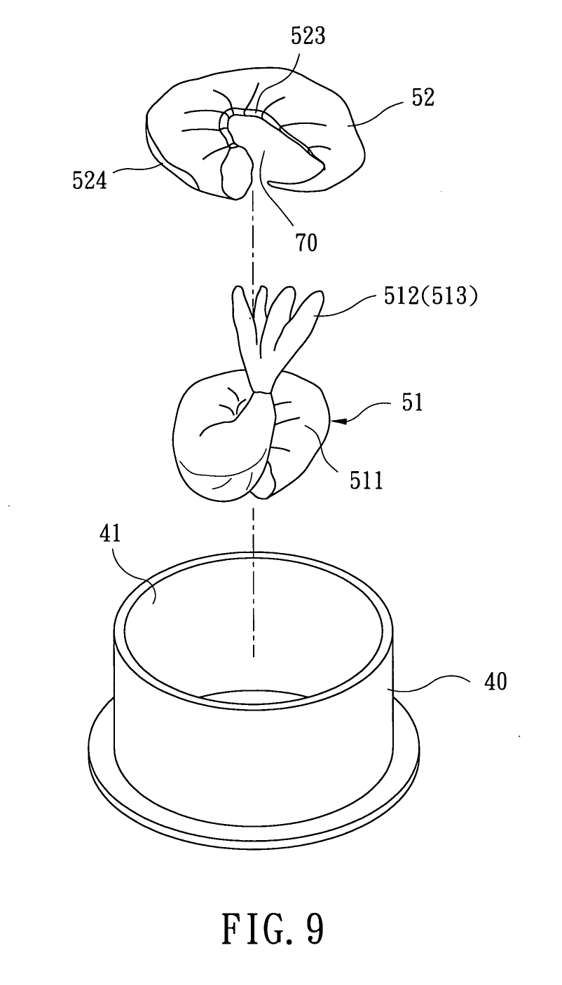

FIGS. 8 and 9 show a frozen shrimp product 5 made by the third preferred embodiment of the process according to the present invention. The shrimp product 5 made by this embodiment differs from that made by the first preferred embodiment in the structure thereof. Specifically, the first raw shrimp 51 has a shank 511 and a tail 512 that extends from the shank 511 and that is covered by a tail shell 513. The second raw shrimp 52 is peeled and has opposite ventral and dorsal sides 523, 524. Upon placing the second raw shrimp 52 in the cylindrical confining space 41 of the confining member 40 to proceed with the stacking step, the second raw shrimp 52 is bent to form a circular shape so as to form an opening 70 confined by the dorsal side 523. In the step of stacking, the tail 512 of the first raw shrimp 51 is inserted through the opening 70 confined by the dorsal side 523 of the second raw shrimp 52.

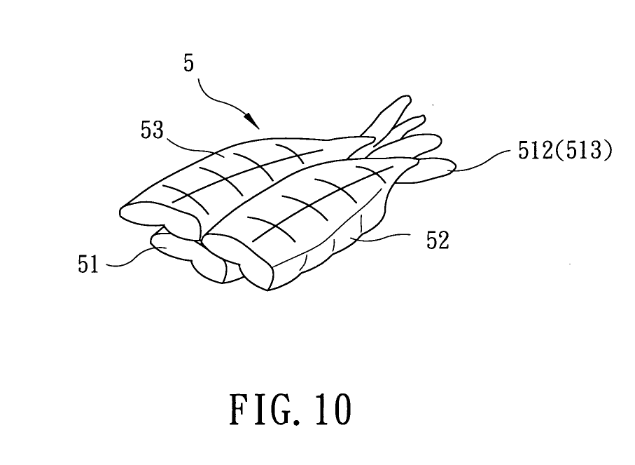

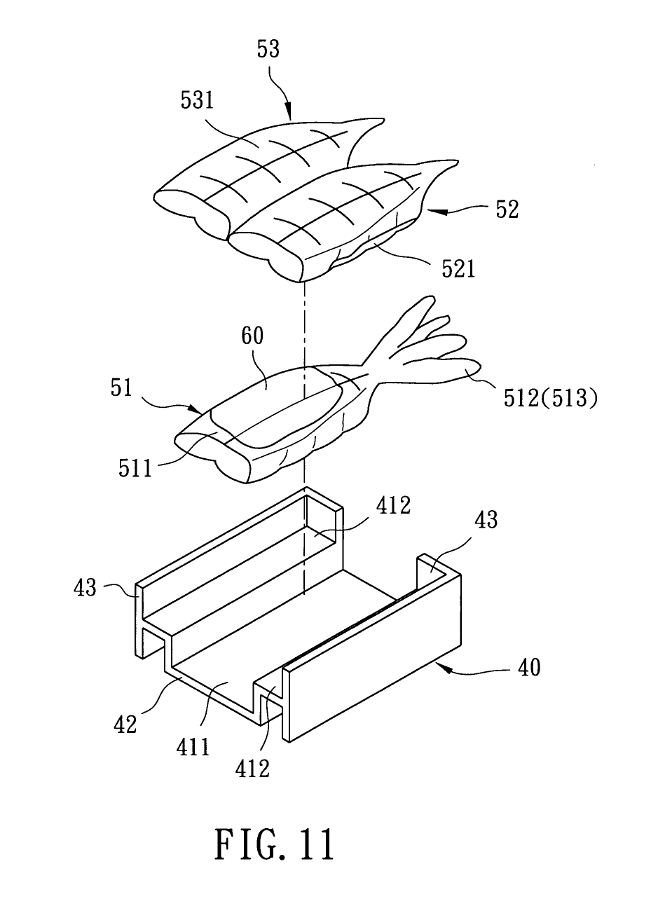

FIGS. 10 and 11 illustrate a frozen shrimp product 5 made by the fourth preferred embodiment of the process according to the present invention. This embodiment differs from the first preferred embodiment in the configuration of the confining member 40, the number and the shape of the shrimps, and the shape of the frozen shrimp product 5. Specifically, in this embodiment, the confining member 40 has a U-shaped wall 42 that defines a first space 411, and two L-shaped wings 43 extending outwardly and oppositely from the U-shaped wall 42. Each of the two L-shaped wings 43 independently defines a second space 412 (see FIG. 11). In addition, the process of this embodiment further includes: stacking a peeled third raw shrimp 53 on the first raw shrimp 51 using the binder 60 such that the peeled third raw shrimp 53 is juxtaposed with the second raw shrimp 52. In this embodiment, the first raw shrimp 51 has a peeled shank 511 and a tail 512 that extends from the shank 511 and that is covered by a tail shell 513. Each of the second and third raw shrimps 52, 53 is peeled and has a shank 521, 531. Each of the first, second, and third raw shrimps 51, 52, 53 is formed with a butterfly slit in the shank 511, 521, 531 of each of the first, second, and third raw shrimps 51, 52, 53 in such a manner to configure each of the shanks 511, 521, 531 of the first, second, and third raw shrimps 51, 52, 53 into two interconnected butterfly halves. During stacking, the two butterfly halves of the first shrimp 51 are received in the first space 411, and are confined by the U-shaped wall 42. One of the butterfly halves of the second shrimp 52 is received in one of the second spaces 412 defined by the L-shaped wings 43, and is confined by the respective one of the L-shaped wings 43. Similarly, one of the butterfly halves of the third shrimp 53 is received in the other of the second spaces 412 defined by the L-shaped wings 43, and is confined by the respective one of the L-shaped wings 43.

With the process of this invention and the use of the binder 60, the adhesion among the shrimps 51, 52, 53 can be enhanced, and the aforesaid drawback as encountered in the prior art can be eliminated. In addition, with the use of the confining member 40, the shrimps are easily positioned, and the frozen shrimp product 5 thus obtained has an improved configuration.

With the invention thus explained, it is apparent that various modifications and variations can be made without departing from the spirit of the present invention. It is therefore intended that the invention be limited only as recited in the appended claims.

What is claimed is:

1. A process for preparing a frozen shrimp product, comprising the steps of:
(a) placing a first raw shrimp in a confining space of a confining member;
(b) stacking a second raw shrimp on the first raw shrimp in the confining space of the confining member using a binder;
(c) pressing the second raw shrimp against the first raw shrimp in the confining space of the confining member so as to form a shrimp product;
(d) taking out the shrimp product from the confining member; and
(e) freezing the shrimp product taken out from the confining member.

2. The process of claim 1, wherein the confining space is cylindrical in shape.

3. The process of claim 2, wherein the first raw shrimp and the second raw shrimp are peeled.

4. The process of claim 3, further comprising a step of (f) placing the shrimp product in a casing after the step (d).

5. The process of claim 2, wherein the second raw shrimp is peeled and has opposite ventral and dorsal sides, the second raw shrimp in the confining space of the confining member being bent so as to form an opening confined by the dorsal side, the first raw shrimp having a shank and a tail that extends from the shank and that is covered by a tail shell, and wherein, in the step of stacking, the tail of the first raw shrimp is inserted through the opening confined by the dorsal side of the second raw shrimp.

6. The process of claim 1, wherein the confining member has a U-shaped wall that defines a first space, and two L-shaped wings extending outwardly and oppositely from the U-shaped wall, each of the two L-shaped wings independently defining a second space.

7. The process of claim 6, wherein the first raw shrimp is received in the first space, the second raw shrimp being received in the second space, the process further comprising placing a peeled third raw shrimp in the second space such that the peeled third raw shrimp is stacked on the first raw shrimp using the binder and is juxtaposed with the second raw shrimp.

8. The process of claim 7, wherein each of the first, second and third raw shrimps has a peeled shank, and is formed with a butterfly slit in the shank of each of the first, second, and third raw shrimps in such a manner to configure each of the shanks of the first, second, and third raw shrimps into two interconnected butterfly halves, and wherein, during stacking, the two butterfly halves of the first raw shrimp are received in the first space, and are confined by the U-shaped wall, one of the butterfly halves of the second raw shrimp being received in the second space defined by one of the L-shaped wings, and being confined by the respective one of the L-shaped wings, one of the butterfly halves of the third raw shrimp being received in the second spaces defined by the other of the L-shaped wings, and being confined by the respective one of the L-shaped wings.

9. The process of claim 1, wherein the binder includes 70 wt % of protein, 25 wt % of a mixture of sodium chloride and natural shell calcium, and 5 wt % of polysaccharide.
